(19) United States
(12) Patent Application Publication
(10) Pub. No.: US 2011/0290393 A1
(43) Pub. Date: Dec. 1, 2011

(54) Tire Tread Comprising Incisions Provided with Projections

(75) Inventors: Eric Berger, Loubeyrat (FR); Matthieu Bonnamour, Pont Du Chateau (FR)

(73) Assignees: MICHELIN RECHERCHE ET TECHNIQUE S.A., Granges-Paccot (CH); SOCIETE DE TECHNOLOGIE MICHELIN, Clermont-Ferrand (FR)

(21) Appl. No.: 13/133,149

(22) PCT Filed: Nov. 13, 2009
(86) PCT No.: PCT/EP09/65168

§ 371 Date: Aug. 17, 2011

(30) Foreign Application Priority Data
Dec. 5, 2008 (FR) 0858296

(51) Int. Cl. B60C 11/13

(52) U.S. Cl. 152/209.21

(57) ABSTRACT

Tread band for a tire comprising a plurality of elements in relief, each element in relief having a contact face and lateral faces, at least some of these elements in relief having at least one incision opening onto two of the said lateral faces, this incision being delimited by a first face and a second face, these first and second faces each comprising projections, each projection of the first face being arranged on the said face so that it can collaborate through contact with a first projection and a second projection on the second face opposite, the said first and second projections of the second face being situated one on each side of the projection of the first face in opposite directions D1 and D2, the pre-contact distance e1 separating one projection of the first face from the first projection of the second face being different from the pre-contact distance e2 separating the projection of the first face from the second projection of the second face, these distances being measured in directions parallel to the directions D1 and D2.

The invention relates to tire tread bands and more particularly still relates to the incisions with which the elements in relief of such tread bands are provided.

In order to improve the grip of tires when running over ground which is covered with water following rain or when driving under winter conditions, it is known practice to provide the tread bands of these tires with a varying number of cuts to create edges and drainage spaces. Included among the cuts, a distinction is made between grooves which have a width such that the opposing faces delimiting them never come into contact with one another during driving provided that the driving is under normal driving conditions. These grooves delimit elements in relief which have lateral faces and a contact face, the latter being the one intended to come into contact with the road surface during driving.

Also included among these cuts are incisions which are of narrow width allowing the faces delimiting each incision to come into contact with one another under certain driving conditions. In the latter instance, use is made of an additional edges effect, these additional edges being created by the incisions, to improve the grip without thereby excessively reducing the rigidity of the tread band thanks to the fact that the faces of these incisions can come into contact.

It is also known practice to lessen the reduction in rigidity still further by creating a mechanical interlocking of the opposing faces of an incision by providing each face with reliefs that collaborate with the reliefs provided on the face opposite in order to reduce as far as possible any relative movement of one face with respect to the face opposite. U.S. Pat. No. 5,783,002 describes such a structure. Here, “in relief” denotes both a part which is recessed or a part which protrudes on a face.

However, and depending on the direction of the force applied by the ground to the tread band during contact and depending on the level of grip resulting from the driving conditions that a user encounters, it is necessary further to improve the performance of tires that have incisions. This is specifically the case when a vehicle is pulling away on snow-covered ground when the greatest flexibility of the tread band is required, as compared with the requirement for braking on dry ground. In the latter configuration, a great deal of firmness and therefore greater rigidity of the elements that make up the tread band is required.

It is an object of the present invention to propose a tire which makes it possible to achieve both the best possible performance when pulling away on snowy ground and when braking on dry ground.

To this end, there is proposed a tread band for a tire comprising a plurality of elements in relief, each element in relief having a contact face and lateral faces, at least some of these elements in relief having at least one incision opening onto two of the said lateral faces, this incision being delimited by a first face and a second face, the first face comprising at least one projection and the second face comprising as many pairs of first and second projections as there are projections on the first face, each projection of the first face being designed to be able to collaborate through contact with a pair of first and second projections on the second face opposite, the said first and second projections of the second face being situated one on each side of each projection of the first face in opposite directions D1 and D2, this tread band being characterized in that the pre-contact distance e1 separating each projection of the first face from the first projection of the second face is different from the pre-contact distance e2 separating each projection of the first face from the second projection of the second face, these distances being measured in directions parallel to the directions D1 and D2.

Thus, a plurality of projections is formed on the first face to collaborate through contact with first projections on the second face opposite following a movement through a distance equal to e1 and with second projections following a movement through a distance equal to e2, these movements being in opposite directions, the distance e1 being strictly less than the distance e2.

Thanks to the tire provided with a tread band according to the invention it is possible in a differential manner to limit the relative movements of one face delimiting an incision with respect to the face opposite; it is thus possible to tailor the said movements to best suit the conditions of use.

Advantageously, this tread band is fitted to a tire comprising a preferred direction of rotation identified by a visible means on this tire such as an arrow molded onto the visible external surface of the said tire. The preferred direction of rotation is determined so that, under a braking force applied by the ground to the tread band under braking, the projections on the faces of the incisions come into contact more quickly than they do when the same tire is subjected to a traction force applied by the ground. Of course, the visible means used to indicate the preferred direction of rotation could be positioned on the tread band itself.

Specifically, when the tire according to the invention finds itself under braking on ground exhibiting high levels of grip (particularly dry ground), the forces applied by the ground to the tread band of the tire are directed in the opposite direction to the direction of travel of the vehicle fitted with the said tire, and this has a tendency to close up the incisions: the opposing faces that delimit an incision have a tendency to move one relative to another in one direction and, after moving through a very short distance, become locked by mutual contact of the projections formed on the faces. This rapid locking also makes it possible to limit the flexing of the thin bands of material between two incisions. A suitable choice of pre-locking distance makes it possible to obtain a near-instantaneous locking effect which is favorable towards effective braking.

By contrast, in a pulling-away situation (with a tractive torque acting on the tire) on ground exhibiting very little grip, the ground applying to the tread band a force which is directed in the desired direction of travel of the vehicle, it is possible, thanks to the invention, to increase the flexing of the thin bands of material to the point that the faces are not locked by mutual contact of the projecting reliefs formed on the said faces.

In a particularly advantageous alternative form of the invention, for each incision provided with projections and having a length L, at least some of the projections of these incisions have an elongate shape and extend over at least 50% of the length L of the incision. More preferably still, the projections of elongate shape extend over the entire length of the incision, in order to provide good control over the forces of contact between the said reliefs when these come into contact under braking on ground exhibiting high levels of grip.

The length L of an incision is measured as the length of one of the two edges that this incision forms on the contact face of the element within which it is formed in the new condition.

In order to optimize the mechanical locking effect, it is advantageous for all the projections formed on the opposing walls of at least one incision to have an elongate shape and to extend over at least 50% of the length of the incision, or more preferably still, over the entire length of the incision.

With a view to limiting also the slippage of one wall of an incision relative to the wall opposite (that is to say in directions perpendicular to the directions D1 and D2), the projections extend over at least 50% of the length L of the incision and have a zigzag or wavy shape. Thus, under cornering combined with braking, the zigzag projections provide both rapid locking of the relative movements of the walls in the directions D1 and D2 and, at the same time, locking of the relative movements of the said walls in directions perpendicular to the directions D1 and D2. More advantageously still, the projections, whether straight or zigzag, extend over at least 95% of the length L of the incision so as to achieve good control over the relative movements of one face with respect to the face opposite.

Other features and advantages of the invention will emerge from the description given hereinafter with reference to the attached drawings which, by way of non-limiting examples, show some embodiments of the subject matter of the invention.

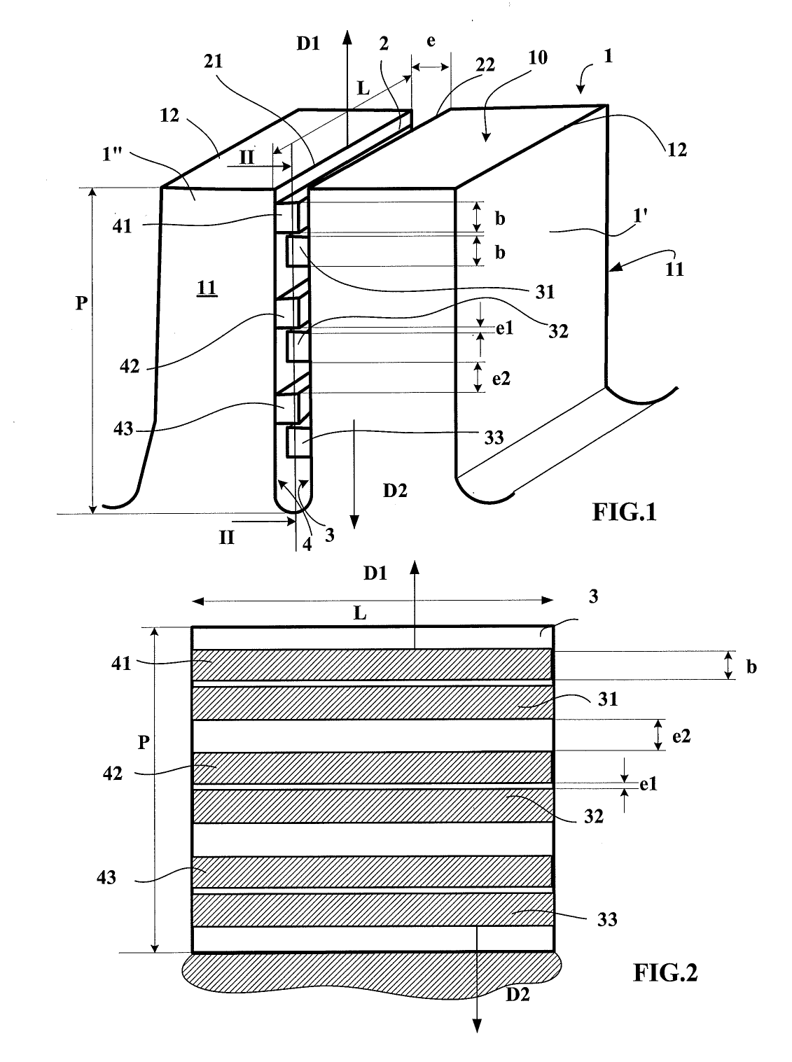

FIG. 1 shows a view of an element of a tread band provided with an incision according to the invention;

FIG. 2 shows a view of a face delimiting the incision shown in cross section in FIG. 1;

FIG. 3 is a cross section through an element of a tread band comprising three incisions provided with projections the cross sections of which are trapezoidal;

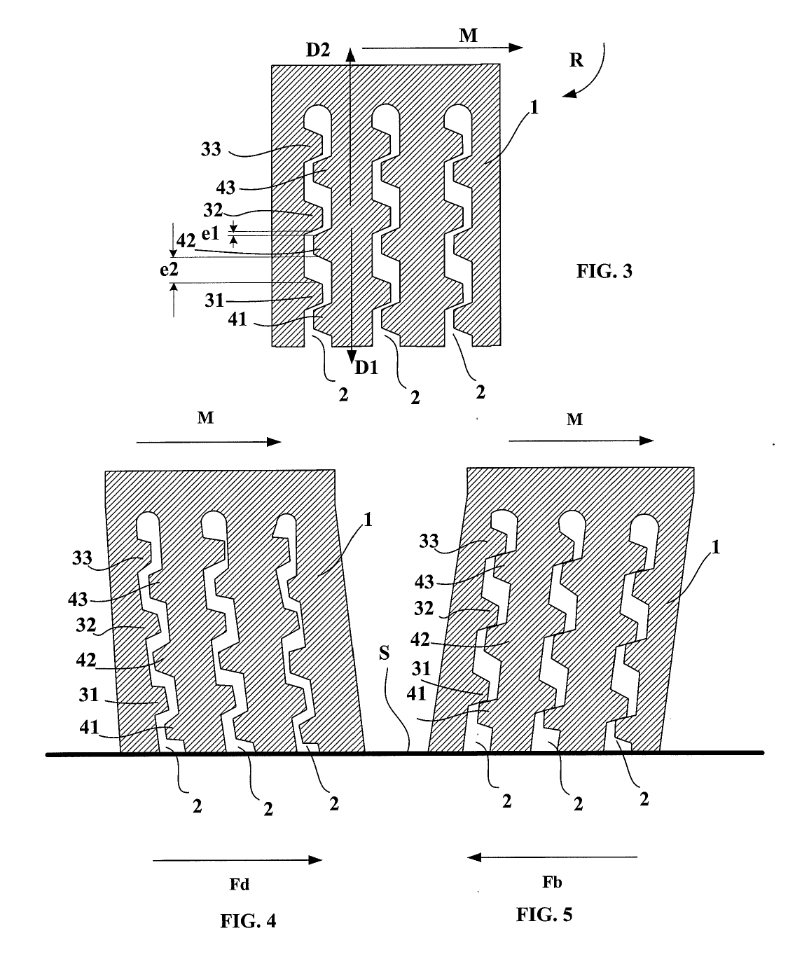

FIG. 4 shows a simulation of the behavior of the incisions of the element shown in FIG. 3, during pulling away;

FIG. 5 shows a simulation of the behavior of the incisions of the element shown in FIG. 3 under braking;

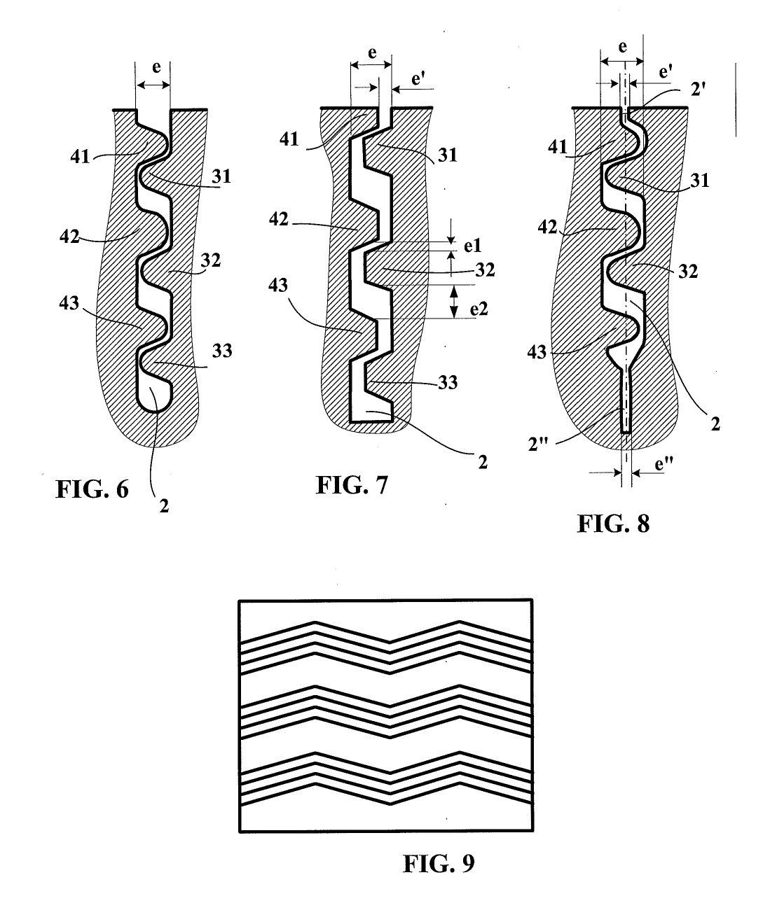

FIG. 6 shows a second alternative form of projections which is better from a manufacturing perspective;

FIG. 7 shows another alternative form of incision whereby a projection intersects the tread surface in the new condition;

FIG. 8 shows an alternative form of embodiment of an incision according to the invention whereby the end parts of the incision are of narrow width and aligned with one another in the directions D1 and D2; and

FIG. 9 shows a face of another alternative form of incision according to the invention whereby the projections extend over part of the length of the incision and have a zigzag shape.

All of the figures that accompany the present description are given by way of indication, and the dimensions, whether absolute or relative, are merely indicative; moreover, one and the same structural element will be identified by the same numerical reference in figures showing different alternative forms of the invention.

FIG. 1 shows a material element 1 of a tread band delimited by grooves. This element 1 comprises a contact face 10 intended to come into contact with the ground when the tire provided with the said tread band is running, and lateral faces 11 intersecting the contact face along edges 12. This element 1 comprises an incision 2 according to the invention which opens onto the contact face 10 to form two edges 21, 22 which are roughly parallel to two edges of the element. This same incision 1 also opens onto two mutually opposing lateral faces 11 of this same element. Thus, two half-elements 1′, 1″, spaced away from one another by the incision 2, are formed. This incision 2 has a length L measured along the contact face 10 of the tread band in the new condition: this length L corresponds in this instance to the length of each edge 21, 22 formed by the incision 2 on the contact face 10.

The incision 1 is delimited by a first face 3 and a second face 4, these first and second faces being situated opposite one another and at a mean distance apart that corresponds to what is defined as the width e of the incision. In the customary way, this width e is less than or equal to 2 mm and preferably less than or equal to 0.6 mm so that when running, the opposing faces 3, 4 come into at least partial contact with one another.

Each of the faces delimiting the incision is provided with several projections which protrude to extend in the direction of the face opposite. These projections have an elongate shape and in this instance extend over the entire length L of the incision and in a direction parallel to the contact face. These projections have a cross section of square shape as can be seen in FIG. 1. The projections on one face are positioned so that they alternate with the projections on the face opposite.

A projection 31 of the first face 3 is arranged on the said first face so that it can collaborate through contact with a pair of projections on the second face 4 opposite, this pair of projections comprising a first projection 41 and a second projection 42, the said first and second projections 41, 42 of the second face 4 being situated one on each side of the projection 31 of the first face 3 in opposite directions D1 and D2. The direction D1 is the direction perpendicular to the contact face and tangential to one of the faces of the incision, this direction D1 being directed towards the outside of the tread (that is to say towards the ground when the tread is running). The direction D2 is the direction perpendicular to the contact face and tangential to one of the faces of the incision, this direction D2 being oriented in the opposite direction to the direction D1.

Likewise, a second projection 32 on the first face 3 is intended to collaborate through contact with another pair of projections 42, 43 of the face opposite; the contact distances here are respectively equal to e1 and to e2 so that each projection of the face 3 can collaborate through contact with a projection of the face 4 opposite after a relative movement of value e1 in the direction D1, and also so that each projection of the face 3 (except for the projection closest to the bottom of the incision, however) can collaborate through contact with a projection of the face 4 opposite after a relative movement of value e2 in the direction D2. One of the projections of this pair is also a projection for the previous pair. The case could be different if the projections of each pair were separate.

The distance e1, prior to contact between the projections, separating a projection 31, 32, 33 of the first face 4 from the first projection 41, 42, 43, respectively, of the second face 4 is different from the distance e2, prior to contact between projections, separating the projection 31, 32 of the first face from the second projection 42, 43, respectively, of the second face, these distances e1 and e2 being measured in directions parallel to the directions D1 and D2.

By virtue of this arrangement it is possible differentially to limit the movements of the first face relative to the second face provided these movements are in a direction perpendicular to the contact face (that is to say in D1 or D2).

For preference, the difference e1 is at least equal to 0.1 mm and at most equal to 0.4 mm. The distance e2 is greater than 0.4 and preferably greater than 1 mm.

FIG. 2 is a cross section on II-II of the element shown in FIG. 1. This FIG. 2 shows the projections 31, 32, 33, 41, 42, 43 of each face 3, 4 in the position they occupy on the tire as it leaves the manufacturing mould, that is to say a tire not mounted on a vehicle. The projections of the first face 3 are flanked by a first and a second projection on the face opposite, except for the projection closest to the bottom of the incision which has only one projection about a distance e1 away. On each face, the projections are distributed in such a way as to be present over the entire extent of the incision so as to be effective irrespective of the level of tread wear. The square cross-sectional shape of the projections is favorable towards good interlocking of the projections. Each projection is of straight elongate shape and extends over the entire length L of the faces delimiting the incision.

FIG. 3 is a cross section of an element & of a tread band comprising three incisions 2 provided with projections 31, 32, 33, 41, 42, 43 the cross sections of which are of trapezoidal shape, the walls of the said projections which are intended to come into contact with one another being oblique. In this configuration, the projections are not yet in contact with one another. It might be possible, by choosing appropriate minimum distances, to have contact between some of the projections through the simple effect of the load-bearing of the vehicle on which the tire is mounted and therefore of the compressing of the tread band. This is particularly favorable under braking because in such an instance there is no possibility (other than the deformation of the materials) for relative movement of the faces of the incisions. This tread is directional, that is to say that the tire provided with such a tread has on its sidewalls a visible means, such as an arrow for example, indicating the set running direction of the tire. This running direction is indicated in FIG. 3 by an arrow R: in the example shown, the tire moves from the left of the drawing to the right in the direction indicated by an arrow M. The directions D1 and D2 are the opposite of one another and are perpendicular to the tread surface of the tread band. The distances e1 and e2 between those parts of the projections that come into contact, as shown with FIGS. 4 and 5, are measured parallel to the directions D1, D2.

FIG. 4 shows a simulation of the behavior of the element 1 of tread band shown in FIG. 3 when a vehicle is pulling away, that is to say under the effect of a tractive load. The direction of travel of the vehicle is indicated by an arrow M, while the tractive force applied by the ground to the tread band is indicated by an arrow Fd oriented in the same direction as the arrow M. In this configuration, the projections 31, 32, 33, 41, 42, 43 formed on the faces of the incisions do not lock the relative movement of the said faces with respect to one another, at least until the movement has reached a value equal to e2. This relative movement favors greater deformation of the element and is therefore favorable to good contact between the element and the ground while this tractive force is being applied.

FIG. 5 shows a simulation of the behavior of the element 1 shown in FIG. 3 under braking, that is to say under a braking force. The direction of the braking force applied by the ground to the tire is indicated by an arrow Fb which is, in this instance, oriented in the opposite direction to the movement identified by the arrow M. In this configuration, the projections 31, 32, 33, 41, 42, 43 formed on the faces of the incisions almost instantaneously lock together as soon as the movement has reached the value equal to e1, or even instantaneously because this value e1 may in part be taken up by the fact that the vehicle is bearing load. This instantaneous locking is favorable to increasing the rigidity of the element and thus limiting the deformation of the element.

FIG. 6 shows a second alternative form of projections 31, 32, 33, 41, 42, 43 that makes it easier to manufacture the molding elements used to mould an incision according to the invention by avoiding the creation of sharp corners. In the case of this alternative form, the cross sections of the projections 31, 32, 33, 41, 42, 43 have, when viewed in the plane of FIG. 6, curved rather than trapezoidal contours, these contours having blend radii connecting the various surfaces. To manufacture a molding element for molding such an incision it is possible to form on a flat metal plate of mean thickness equal to the distance e2, and then by removing material create regions corresponding to the zones between the projections, of length e1, finally forming the molding element by drawing.

FIG. 7 shows another alternative form of incision whereby a projection 31 on a face 3 of an incision 2 intersects the contact face 10 of the tread element in the new condition. When the tread is in the new condition, the width of the incision visible from the contact face is reduced to e′ (less than the mean width e of the incision), and this is favorable in certain tests performed when the tire is new.

FIG. 8 shows an alternative form of embodiment of an incision 2 according to the invention, whereby the incision 2 of mean width e comprises an end part 2′ opening onto the contact face 10 and an end part 2″ in the bottom of the incision. In this alternative form, these end parts are of width e″ substantially less than the mean width e of the incision. Further, these end parts 2′, 2″ are formed in line with one another in the directions D1 and D2. Thus, it makes it possible to make the mechanical behavior of the tread band element symmetric about the incision 2, thus avoiding any wobble.

Tires according to the invention have been produced and compared in pulling-away tests on snow-covered ground and braking tests on dry ground using reference tires. The reference tires have the same tread patterns and the same incisions, the only difference being that the projections of the incisions of the reference tires were all the same distances apart.

The tires were of the size 205/55 R16 and were fitted to an Audi A4.

The table which follows shows the results obtained in a braking test on dry ground, braking from 100 km/h to 0 km/h, with which the stopping distance is measured. An acceleration test was also carried out on snow-covered ground, and in this test the acceleration was measured continuously as a function of time and a mean acceleration over the first four seconds of the test was calculated.

Performance better than the base 100, corresponding to the performance of the reference tire in each test, indicates an improvement in the said performance aspect.

| | | Tire according to |
|---|---|---|
| | Reference tire | the invention |
| Pulling away on | 100 | 107 |
| snow-covered | | |
| ground | | |
| Braking on dry | 100 | 103 |
| ground | | |

FIG. 9 shows a view of a face delimiting an incision according to the invention and in which the projections formed on this face have an elongate shape extending over the entire length of the incision and made up of a plurality of broken zigzag lines.

The invention is not restricted to the examples described and depicted and various modifications can be made thereto without departing from its scope. In particular, this invention applies to the case, not shown here, of incisions the line of which, on the contact face of the elements, follows a non-rectilinear geometry and particularly a geometry made up of waves or of zigzags. In another alternative form, at least one incision provided with projections on the faces that delimit it is inclined by an angle at most equal to 30 degrees to a direction perpendicular to the contact face of the element in which the said incision is formed.

1-9. (canceled)

10. A tire having a preferred direction of rotation identified by a visible means on this tire, this tire being provided with a tread including a plurality of elements of relief, each element of relief having a face of contact and lateral faces, at least some of these elements of relief having at least an incision opening onto two of the aforesaid lateral faces, this incision being delimited by a first face and a second face, these two faces being connected by a bottom, this incision being provided over its first face and its second face with protuberances, wherein each protuberance of the first face being able to cooperate by contact with at least a protuberance of the second face during a displacement of the first face relative to the second face in a direction D1 or a direction D2 opposed to the direction D1, these two D1 directions and D2 being parallel to a direction extending between the bottom of the incision and the contact face of the element of relief provided with this incision, and wherein the preferred direction of rotation of the tire is chosen so that—under the effect of a braking effort exerted by the ground on the tread during a braking operation, the protuberances of the first face of each incision are more quickly in contact with the protuberances of the second face than when this same tire is subjected to a driving effort exerted by the ground, i.e. the distance e1 of relative displacement of the first face relative to the second face in the direction D1 until the contact of the protuberances of the aforesaid first face with the protuberances of the aforesaid second face is different from the distance e2 of relative displacement of the first face compared to the second face in the direction D2 opposed to the direction D1 until the contact of the protuberances of the aforesaid the first face with the protuberances of the aforesaid the second face.

11. The tire according to claim 10, wherein each incision provided with projections having a length L, at least some of the projections have an elongate shape and extend over at least 50% of the length L of the incision.

12. The tire according to claim 11, wherein all the projections formed on the opposing faces of at least one incision have an elongate shape and extend over at least 50% of the length L of the incision.

13. The tire according to claim 12, wherein the projections extend over at least 50% of the length L of the incision and have a zigzag or wavy shape.

14. Tire according to claim 10, wherein the projections extend over at least 95% of the length L of the incision.

15. The tire according to claim 10, wherein each incision of mean width e comprising projections comprises end parts of width e″ smaller than the mean width e of the incision, these end parts also being positioned in alignment with one another and in the mid plane of the incision.

16. The tire according to claim 10, wherein at least one incision provided with projections on the faces delimiting it is inclined by an angle at most equal to 30 degrees to a direction perpendicular to the contact face of the element in which the said incision is formed.
